(19) United States
(12) Patent Application Publication
(10) Pub. No.: US 2005/0173572 A1
(43) Pub. Date: Aug. 11, 2005

(54) Household bean milk and bean curd maker closed by gravity

(76) Inventor: Hong-bae Kim, Koyang-city (KR)

Correspondence Address: SHLESINGER, ARKWRIGHT & GARVEY LLP;Suite 600, 1420 King Street, Alexandria, VA, 22314, US

(21) Appl. No.: 10/960,759

(22) Filed: Oct. 8, 2004

(30) Foreign Application Priority Data
Oct. 8, 2003 (KR) 2003-31676

(51) Int. Cl. A23L 1/00

(52) U.S. Cl. 241/92; 99/348

(57) ABSTRACT

Disclosed herein is a household bean milk and bean curd maker closed by the gravity. The maker includes a housing defining a cavity therein, and a main body provided on an upper portion of the housing to open or close the housing. The maker further includes a guide protrusion provided at a predetermined position on an upper portion of the housing, and a guide hole provided at a predetermined position on a lower portion of the main body to engage with the guide protrusion. The maker of this invention is constructed so that the main body is accurately guided on the housing by the guide protrusion and the guide hole, and the coupling of the main body to the housing is maintained by the weight of the main body, thus preventing vibration, noise, and accidents.

### CROSS-REFERENCE TO RELATED APPLICATIONS

This application claims priority of Korean application no. 2003-31676, filed Oct. 8, 2003, which is incorporated herein by reference.

### FIELD OF THE INVENTION

The present invention relates generally to household bean milk and bean curd makers and, more particularly, to a household bean milk and bean curd maker, which is constructed so that a main body is accurately guided on a housing by a guide protrusion and a guide hole, and the coupling of the main body to the housing is maintained by the weight of the main body, thus preventing vibration, noise, and accidents.

### BACKGROUND OF THE INVENTION

A conventional method of making bean milk and bean curd has a problem in that several processes are individually executed, thus it is inconvenient and complicated to make bean milk and bean curd, and it takes longer time to make the bean milk and the bean curd, thereby the conventional method is inefficient.

In order to solve the problems, there have been proposed various devices for easily and conveniently making bean milk and bean curd at home. For example, there are Korean Patent No. 225772, Korean Patent No. 228659, Korean U.M. Registration No. 158856, Korean U.M. Registration No. 250843, etc, that are disclosed by the applicant of the present invention. The Korean Patent No. 225772 was published on Oct. 15, 1999, and is titled “household bean curd maker”. The Korean Patent No. 2000-228659 was published on Mar. 15, 2000, and is titled “household bean curd maker”. The Korean U.M. Registration No. 158856 was registered on Jul. 16, 1999, and is titled “household bean curd maker”. The Korean U.M. Registration No. 250843 was registered on Oct. 5, 2001, and is titled “household bean curd maker with fixed-type blade unit”.

A conventional household bean milk and bean curd maker will be described in the following with reference to the attached drawing.

FIG. 1 is a sectional view of the conventional household bean milk and bean curd maker. As shown in FIG. 1, the conventional household bean milk and bean curd maker includes a housing 1 which has a cavity to contain water therein. A main body 2 is provided on an upper portion of the housing 1 to open or close the housing 1, like a lid. A drive motor 3 is installed in a predetermined portion of the main body 2, and generates rotating power when electricity is applied to the drive motor 3. A drive shaft 4 transmits the rotating power from the drive motor 3. A cutting blade 5 is provided at an end of the drive shaft 4. A rod-shaped heater 6 downwardly extends from the main body 2, and generates heat when electricity is applied to the heater 6, thus heating an interior of the housing 1. A temperature sensing bar 7 detects the temperature of the interior of the housing 1. A filter net 8 is detachably mounted to a predetermined portion of the main body 2, and contains beans therein.

The conventional household bean milk and bean curd maker constructed as described above is operated as follows.

First, a user puts water into the housing 1. Beans are put into the filter net 8 which is detached from the main body 2, and then the filter net 8 containing the beans is mounted to the lower portion of the main body 2. Afterwards, the main body 2 is placed on the upper portion of the housing 1 so that the filter net 8 is put into the housing 1.

Next, when a power switch (not shown) is turned on to apply electricity to the household bean milk and bean curd maker, a control unit (not shown) outputs a control signal to operate the heater 6 and the temperature sensing bar 7. At this time, a primary heating process is executed while maintaining a predetermined temperature, for a predetermined period.

When the primary heating process has been completed, the control unit (not shown) outputs a control signal to operate the drive motor 3. As the drive motor 3 is operated, the beans contained in the filter net 8 are ground by the cutting blade 5 provided at the end of the drive shaft 4. While the beans are ground, turbulence of water contained in the housing 1 is caused by rotation of the cutting blade 5. By the turbulence, bean grains which are finely ground by the cutting blade 5 come out of the filter net 8. Thus, the beans ground by the cutting blade 5 are divided into bean-curd dregs which remain in the filter net 8, and the extract of protein which flows out of the filter net 8.

Thereafter, the control unit (not shown) outputs a control signal to operate the heater 6 and the temperature sensing bar 7. At this time, a secondary heating process is executed while maintaining a predetermined temperature, for a predetermined period. Through the above-mentioned process, bean milk is obtained.

When the user desires to make bean curd, the user takes the heated extract of protein out of the housing 1. Next, the coagulant is added to the heated extract of protein so as to coagulate the extract of protein. Thereafter, the coagulated protein is pressed in the frame to produce the bean curd.

However, the conventional household bean milk and bean curd maker has a problem in that the maker is mainly manipulated by a woman who is poor at manipulation of a mechanical device, so that the maker may be operated while the main body 2 is not firmly coupled to the housing 1.

Further, if the main body 2 is not accurately coupled to the housing 1, electricity is not supplied to the maker, or excessive vibration occurs and noise increases in the case that electricity is supplied to the maker. When excessive vibration occurs, the maker falls down, so that hot liquid escapes out of the maker, thus causing an accident.

### OBJECTS AND SUMMERY OF THE INVENTION

Accordingly, the present invention has been made keeping in mind the above problems occurring in the prior art, and an object of the present invention is to provide a household bean milk and bean curd maker closed by gravity, which is constructed so that a main body is accurately guided on a housing by a guide protrusion and a guide hole, and the coupling of the main body to the housing is maintained by the weight of the main body, thus preventing vibration, noise, and accidents.

### BRIEF DESCRIPTION OF THE DRAWINGS

FIG. 1 is a sectional view of a conventional household bean milk and bean curd maker;

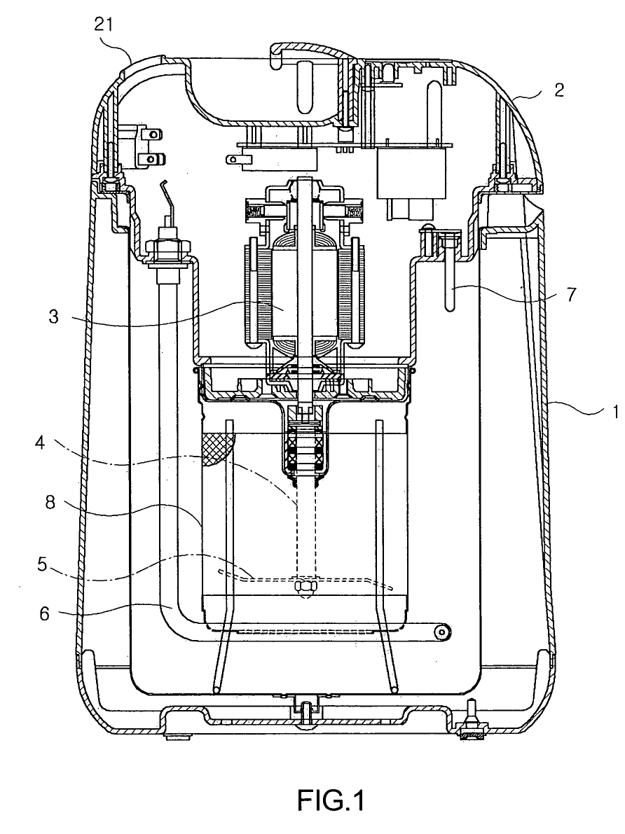

FIG. 2 is a perspective view of a household bean milk and bean curd maker closed by the gravity, according to the first embodiment of the present invention; and

FIG. 3 is a perspective view of a household bean milk and bean curd maker closed by the gravity, according to the second embodiment of the present invention.

### DETAILED DESCRIPTION OF THE INVENTION

Hereinafter, preferred embodiments of the present invention will be described in detail with reference to the attached drawings so that those skilled in the art may easily implement this invention. The above and other objects, features and other advantages of the present invention will be more clearly understood from the following detailed description.

Since the preferred embodiments of the present invention have been disclosed for illustrative purposes, those skilled in the art will appreciate that various modifications, additions and substitutions are possible, without departing from the scope and spirit of the invention as disclosed in the accompanying claims.

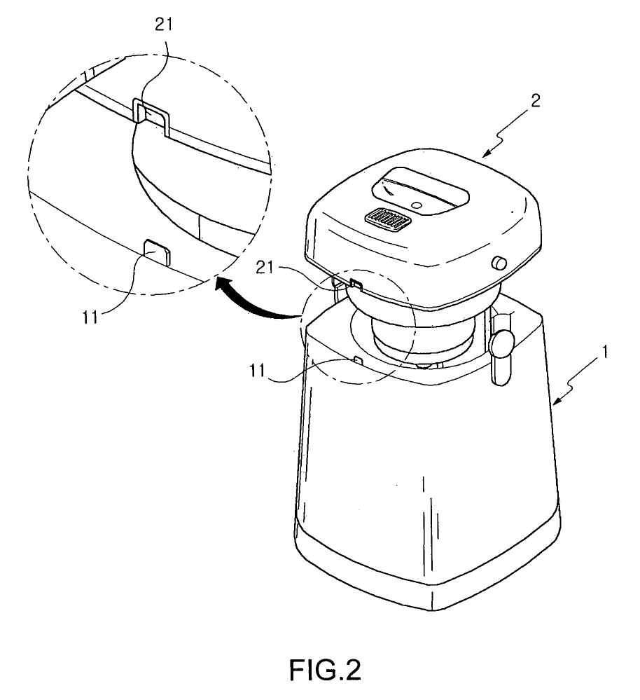

A household bean milk and bean curd maker closed by the gravity, according to the first embodiment of the present invention is constructed as follows. As shown in FIG. 2, the household bean milk and bean curd maker includes a housing 1 and a main body 2. The housing 1 has a cavity therein. The main body 2 is provided on an upper portion of the housing 1 to open or close the housing 1, like a lid. Further, a guide protrusion 11 is provided at a predetermined position on an upper portion of the housing 1. A guide hole 21 is provided at a predetermined position on a lower portion of the main body 2 to engage with the guide protrusion 11.

The household bean milk and bean curd maker closed by the gravity constructed as described above is operated as follows.

When a user desires to couple the main body 2 to the housing 1, the main body 2 is placed on the housing 1. At this time, the guide protrusion 11 provided at a predetermined position on the upper portion of the housing 1 is fitted into the guide hole 21 provided at a predetermined position on the lower portion of the main body 2. Thereby, the main body 2 is securely coupled to the housing 1.

In this case, the number of guide protrusions 11 and guide holes 21 is not limited to one. That is, in order to securely couple the main body 2 to the housing 1, the guide protrusion 11 may comprise a plurality of guide protrusions, and the guide hole 21 may comprise a plurality of guide holes.

Even if the guide protrusion 11 is not accurately aligned with the guide hole 21, the guide protrusion 11 easily engages with the guide hole 21 due to the weight of the main body 2, which has relatively heavy components, such as a drive motor 3, a drive shaft 4, and a cutting blade 5. Further, the coupling of the main body 2 to the housing 1 is maintained by the weight of the main body 2.

Further, it is possible to change the positions of the guide protrusion 11 and the guide hole 21. That is, the guide hole 21 may be provided at a predetermined position on the upper portion of the housing 1, and the guide protrusion 11 may be provided at a predetermined position on the lower portion of the main body 2.

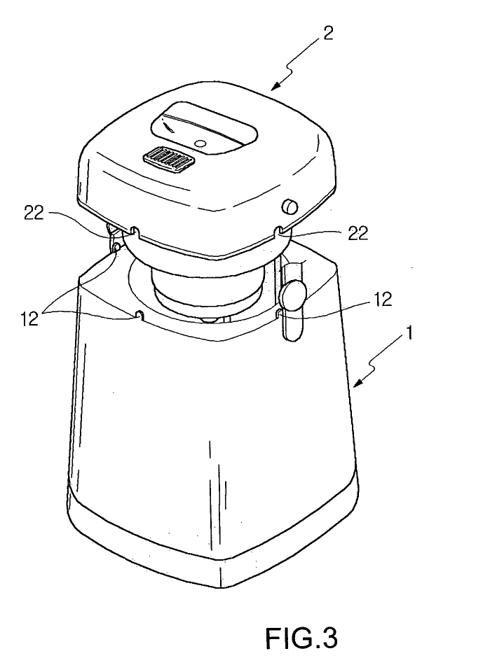

A household bean milk and bean curd maker closed by the gravity according to the second embodiment of the present invention is constructed as follows. As shown in FIG. 3, the household bean milk and bean curd maker includes a housing 1 and a main body 2. The housing 1 has a cavity therein. The main body 2 is provided on an upper portion of the housing 1 to open or close the housing 1, like a lid. Further, a plurality of guide protrusions 12 is provided on the upper portion of the housing 1. A plurality of guide holes 22 is provided on a lower portion of the main body 2 to engage with the corresponding guide protrusions 12.

For smooth engagement of the guide protrusions 12 with the guide holes 22, it is preferable that the edges of the guide protrusions 12 and the guide holes 22 have a gently curved shape.

The general construction of the household bean milk and bean curd maker according to the second embodiment remains the same as that of the first embodiment, except that the guide protrusion comprises a plurality of guide protrusions 12 and the guide hole comprises a plurality of guide holes 22. Thus, the operation of the household bean milk and bean curd maker according to the second embodiment will not be described herein.

As described above, the present invention provides a household bean milk and bean curd maker, which is constructed so that a main body and a housing are accurately guided by a guide protrusion and a guide hole, and the coupling of the main body to the housing is maintained by the weight of the main body, thus preventing vibration, noise, and accidents.

While this invention has been described as having a preferred design, it is understood that it is capable of further modifications, and uses and/or adaptations of the invention and including such departures from the present disclosure as come within the known customary practice in the art to which the invention pertains, and as may be applied to the central features hereinbefore set forth, and fall within the scope of the invention or limits of the claims appended hereto.

1. A household bean milk and bean curd maker closed by the gravity, comprising:
a) a housing defining a cavity therein, and a main body provided on an upper portion of the housing to open or close the housing;
b) a guide protrusion provided at a predetermined position on an upper portion of the housing; and
c) a guide hole provided at a predetermined position on a lower portion of the main body to engage with the guide protrusion.

2. The household bean milk and bean curd maker as set forth in claim 1, wherein:
a) the guide protrusion comprises a plurality of guide protrusions, and the guide hole comprises a plurality of guide holes.
